(19) United States
(12) Patent Application Publication
(10) Pub. No.: US 2014/0037159 A1
(43) Pub. Date: Feb. 6, 2014

(54) APPARATUS AND METHOD FOR ANALYZING LESIONS IN MEDICAL IMAGE

(71) Applicant: Samsung Electronics Co., Ltd., Suwon-si (KR)

(72) Inventors: Baek-Hwan CHO, Seoul (KR); Yeong-Kyeong SEONG, Suwon-si (KR)

(73) Assignee: Samsung Eletronics Co., Ltd., Suwon-si (KR)

(21) Appl. No.: 13/903,359

(22) Filed: May 28, 2013

(30) Foreign Application Priority Data
Aug. 3, 2012 (KR) 10-2012-0085401

(51) Int. Cl. G06T 7/00

(52) U.S. Cl. CPC G06T 7/0012
USPC 382/128

(57) ABSTRACT

Provided are apparatuses and methods for analyzing a lesion in an image. A Threshold Adjacency Statistics (TAS) feature may be extracted from a medical image, and a pattern of the lesion may be classified using the extracted TAS feature.

### CROSS-REFERENCE TO RELATED APPLICATION

This application claims the benefit under 35 USC §119(a) of Korean Patent Application No. 10-2012-0085401, filed on Aug. 3, 2012, in the Korean Intellectual Property Office, the entire disclosure of which is incorporated herein by reference for all purposes.

### BACKGROUND

1. Field

The following description relates to an apparatus and a method for analyzing a lesion in a medical image.

2. Description of the Related Art

Image analyzing devices may be used to identify biological systems and diseases in biological and medical industries. Image capture devices have been significantly improved in recent years. As a result, the devices are able to produce a great amount of images at a high speed. Under these circumstances, efforts have been made to develop technologies for automatically analyzing an image using a computer.

Recently, a study has been released about a technique for automatically analyzing a protein in a microscopic image using a Threshold Adjacency Statistics (TAS) feature (See, N. A. Hamilton et. al., Fast automated cell phenotype image classification, BMC Bioinformatics, 8, 110 (2007)). This technique is effective in analyzing a protein in a fluorescence microscopic image.

### SUMMARY

In an aspect, there is provided an apparatus for analyzing a lesion in an image, the apparatus including a TAS feature extractor configured to extract a Threshold Adjacency Statistic (TAS) feature from the image, and a lesion classifier configured to classify a pattern of a lesion in the image based on the extracted TAS feature.

The apparatus may further comprise an image pre-processor configured to pre-process the image by adjusting at least one of brightness, contrast, and color distribution of the image, wherein the TAS feature extractor is configured to extract the TAS feature from the pre-processed image.

The extractor may comprise an image binarizer configured to binarize the image, an histogram generator configured to generate a histogram based on a number of white pixels that surround each white pixel included in the binarized medical image, and a TAS feature vector generator configured to generate a TAS feature vector based on the generated histogram.

The image binarizer may be configured to calculate an average value and a deviation value of pixels, each of which have a pixel intensity that is higher than a pixel intensity of a background of the image, and binarize the image using the calculated average value and deviation value.

The lesion classifier may be configured to classify the pattern of the lesion by applying the TAS feature based on a machine learning algorithm.

The machine learning algorithm may comprise at least one of an artificial neural network, a Support Vector Machine (SVM), a decision tree, and a random forest.

The lesion classifier may be configured to classify the lesion as either malignant or benign.

In an aspect, there is provided an apparatus for analyzing a lesion in an image, the apparatus including a lesion area detector configured to detect a lesion area from the image, a lesion area pre-processor configured to generate an image with a pre-processed lesion area by pre-processing the detected lesion area, a TAS feature extractor configured to extract a TAS feature from the image with a pre-processed lesion area, and a lesion classifier configured to classify a pattern of a lesion based on the extracted TAS feature.

The lesion area pre-processor may be configured to generate the image with a pre-processed lesion area using a pre-processing algorithm comprising at least one of a contrast enhancement algorithm, a speckle removal algorithm, a top hat filter, and a binarization algorithm.

The apparatus may further comprise a second feature extractor configured to extract additional features of the lesion area from the image with a pre-processed lesion area, the additional features including at least one of a shape, brightness, texture and correlation with other areas surrounding the lesion area, wherein the lesion classifier is configured to classify a pattern of a lesion using the extracted second feature.

In an aspect, there is provided a method for analyzing a lesion in an image, the method including extracting a TAS feature from the image, and classifying a pattern of a lesion in the image based on the extracted TAS feature.

The method may further comprise pre-processing the medical image by adjusting at least one of brightness, contrast, and color distribution of the image, wherein the extracting of the TAS feature comprises extracting the TAS feature from the pre-processed medical image.

The extracting of the TAS feature may comprise binarizing the image, generating a histogram based on a number of white pixels that surround each white pixel included in the binarized image, and generating a TAS feature vector based on the generated histogram.

The binarizing of the image may comprise calculating an average value and a deviation value of pixels, each having a pixel intensity higher than a pixel intensity of a background of the image, and binarizing the image using the calculated average value and deviation value.

The classifying of the pattern of a lesion may comprise classifying the pattern of a lesion by applying the TAS feature based on a machine learning algorithm.

The machine learning algorithm may comprise at least one of an artificial neural network, a SVM, a decision tree and a random forest.

In an aspect, there is provided a method for analyzing a lesion in an image, the method including detecting a lesion area from the image, generating an image with a pre-processed lesion area by pre-processing the detected lesion area, extracting a TAS feature from the image with a pre-processed lesion area, and classifying a pattern of a lesion based on the extracted TAS feature.

The generating of the image with a pre-processed lesion area may comprise generating the image with a pre-processed lesion area using a pre-processing algorithm comprising at least one of a contrast enhancement algorithm, a speckle removal algorithm, a top hat filter, and a binarization algorithm.

The extracting of the TAS feature may comprise binarizing the image with a pre-processed lesion area, generating a histogram based on a number of white pixels that surround each white pixel included in the binarized image, and generating a TAS feature vector based on the generated histogram.

The method may further comprise extracting additional features of a lesion area from the image with a pre-processed lesion area, the additional features including at least one of a shape, brightness, texture, and correlation with other areas surrounding the lesion area, wherein the classifying of the pattern of the lesion comprises classifying the pattern of a lesion using the extracted second feature.

Other features and aspects will be apparent from the following detailed description, the drawings, and the claims.

### BRIEF DESCRIPTION OF THE DRAWINGS

FIG. 1 is a diagram illustrating an example of an apparatus for analyzing a lesion.

FIGS. 2A through 2C are diagrams illustrating examples of a method for extracting a Threshold Adjacency Statistic (TAS) feature.

FIG. 3 is a diagram illustrating another example of an apparatus for analyzing a lesion.

FIGS. 4A and 4B are diagrams illustrating an example of a process for extracting a lesion area and a process for pre-processing the lesion area.

FIG. 5 is a diagram illustrating an example of a method for analyzing a lesion.

FIG. 6 is a diagram illustrating an example of a method for extracting a TAS feature shown in the method of FIG. 5.

FIG. 7 is a diagram illustrating another example of a method for analyzing a lesion.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

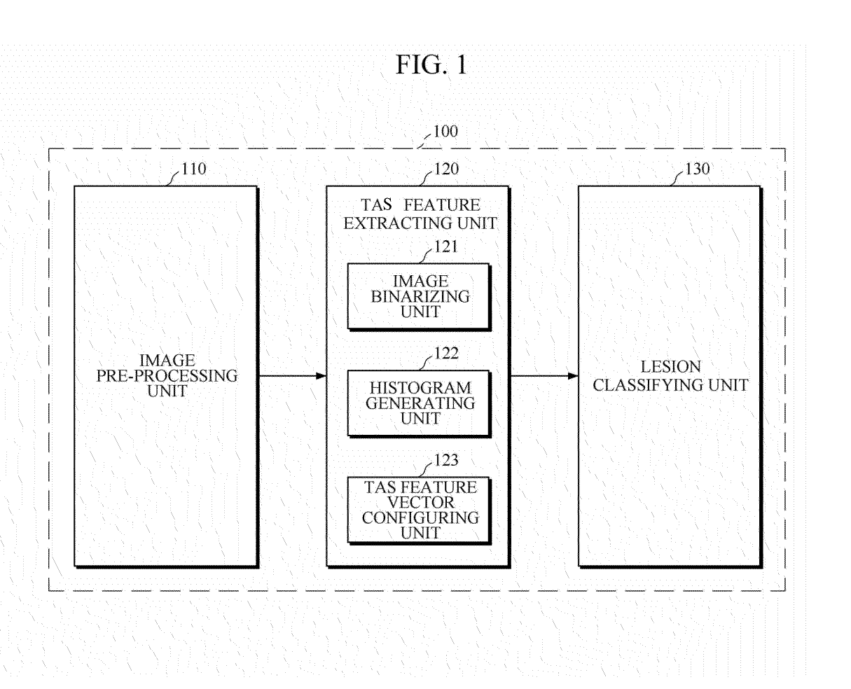

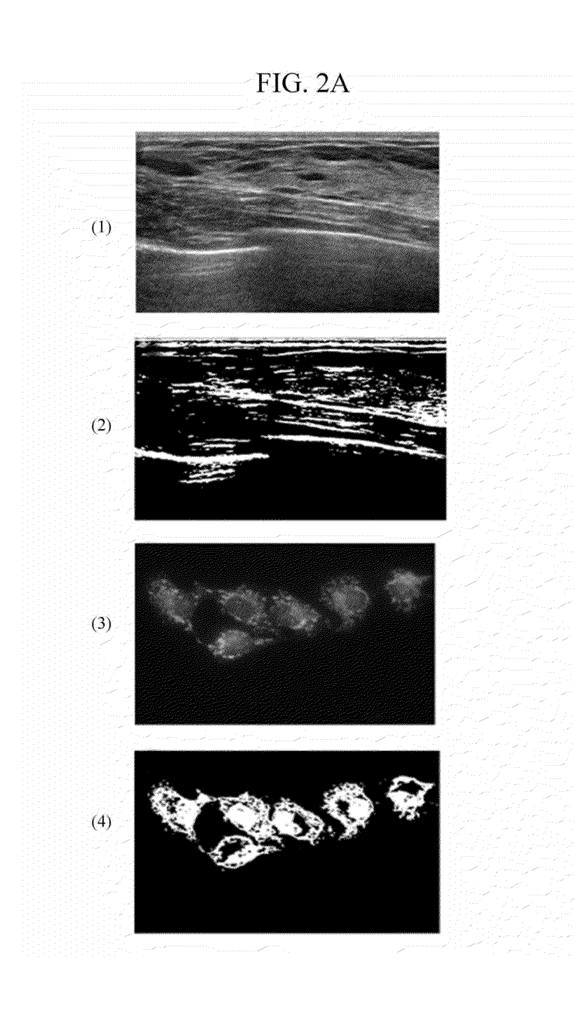

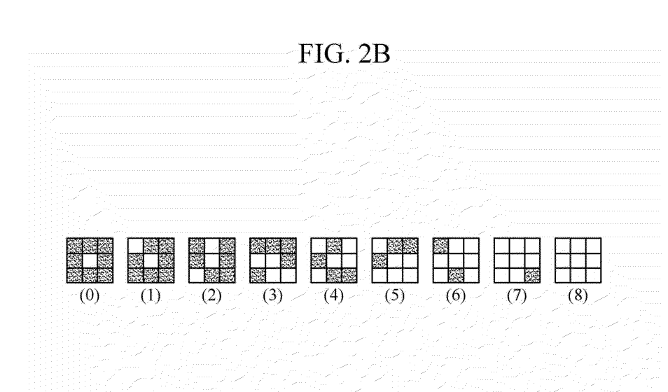

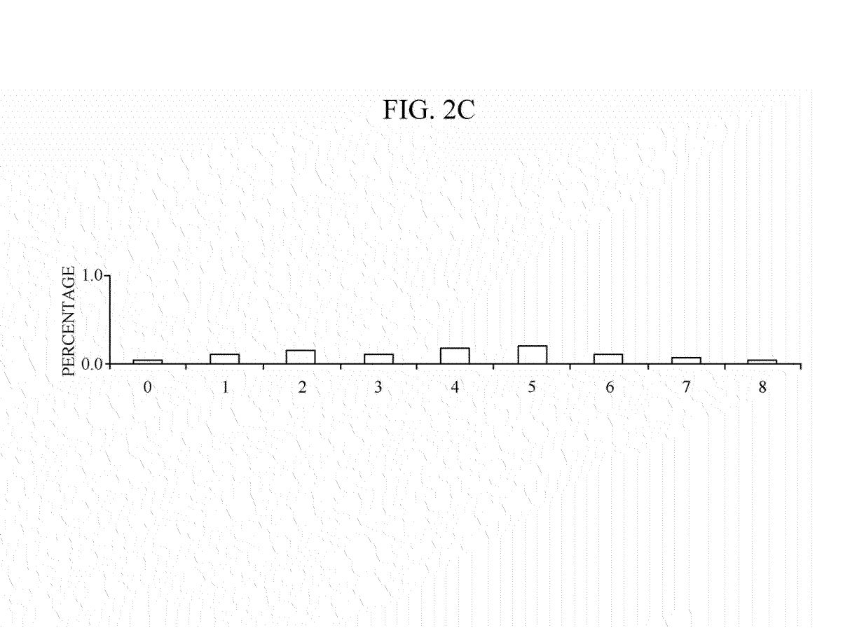

FIG. 1 illustrates an example of an apparatus for analyzing a lesion. In addition, FIGS. 2A and 2B are diagrams illustrating examples of process for extracting Threshold Adjacency Statistic (TAS) features.

Referring to FIG. 1, an apparatus for analyzing a lesion 100 includes an image pre-processing unit 110, a TAS feature extracting unit 120, and a lesion classifying unit 130. As an example, a hardware device may include the image pre-processing unit 110, the TAS feature extracting unit 120, and the lesion classifying unit 130 all together, or, as another example, one or more of the above functional units may be included in another device.

According to an analytic purpose, the image pre-processing unit 110 may adjust brightness, contrast, and/or color distribution of an image, for example, captured by a medical image capture device. The medical image capture device may measure a patient's body part and may transform the measurement into an electrical signal. As an example, the medical image capture device may include an ultrasound device, an MRI device, a CT device, and the like. When being output, the electrical signal may change as time goes by, and may be transmitted to the image pre-processing unit 110 in the form of an image.

The TAS feature extracting unit 120 may extract a TAS feature from an image captured by a medical image capture device. For example, the medical image may be processed in the image pre-processing unit 110 based on an analytic purpose, and the TAS feature extracting unit 120 may extract a TAS feature from the image that is pre-processed in the image pre-processing unit 110. The method for extracting a TAS feature is an improvement over the study conducted by Hamilton, because the method described herein is suitable for analyzing a lesion in a medical image. The TAS feature extracting unit 120 may extract a TAS feature from an entire area of a medical image or from a predetermined area size of a medical image, for example, by shifting from one medical image to another using a sliding window technique.

Referring to FIG. 1, the TAS feature extracting unit 120 may include an image binarizing unit 121, a histogram generating unit 122, and a TAS feature vector configuring unit 123.

The image binarizing unit 121 may binarize an image captured by a medical image capture device or an image pre-processed by the image pre-processing unit 110. FIG. 2A illustrates an example of an ultrasound image 1 of a breast, an image 2 which is binarized of the ultrasound image 1 of the breast using a predetermined threshold, a fluorescence microscopic image 3 of a cell, and an image 4 which is binarized from the fluorescence microscopic image 3 using a predetermined threshold.

The image binarizing unit 121 may estimate a value of a pixel intensity of the background in a medical image, and calculate an average value μ and a deviation value σ of pixels which have a value of a pixel intensity that is higher than the value of a pixel intensity of the background. An average value μ and a deviation value σ of pixels may be calculated by the binarizing unit 121.

The image binarizing unit 121 may binarize an image using the calculated average value μ and the calculated deviation value σ. For example, if a value of the pixel intensity of a pixel in an image is higher than a predetermined threshold (for example, μ+σ, μ+2σ and μ+3σ), the pixel may be converted into a white pixel. As another example, if a value of a pixel intensity of a pixel in a medical image is less than a predetermined threshold, the pixel may be converted into a black pixel. These are merely examples, and it should be appreciated that an image may be binarized in various ways.

The image binarizing unit 121 may invert the binarized image. The inverted image is a binarized image that is inverted. The histogram generating unit 122 may generate a histogram using the binarized image or the corresponding inverted image to generate a TAS feature vector

The histogram generating unit 122 may count the number of white pixels surrounding each white pixel included in a binarized image or an inverted image. Based on the number of surrounding white pixels, the histogram unit 122 may generate a histogram. FIG. 2B illustrates examples of counting the number of white pixels out of eight pixels surrounding a central white pixel. The number of surrounding white pixels is shown below each image in an ascending order from the left. A different number of surrounding pixels may be set for an analytic purpose. For example, four pixels, such as those on the top, the bottom, the left, and the right of a central pixel, may be set as surrounding pixels in the case of a 2D image. In the case of a 3D image, eight pixels may be set as surrounding pixels, as shown in FIG. 2B. As another example, six pixels, eighteen pixels, twenty-six pixels, or the like may be set as surrounding pixels.

FIG. 2C illustrates an example of a histogram. Because the first image from the left in FIG. 2B has zero white pixels surrounding a central white pixel, the first image is represented as a bin of “0”. In addition, the second image from the left in FIG. 2B has one white pixel that surrounds a central white pixel. Accordingly, the second image is represented as a bin of “1”.

The TAS feature vector configuring unit 123 may configure or modify a TAS feature vector based on the histogram generated by the histogram generating unit 122.

The lesion classifying unit 130 may classify a pattern of each of the lesions using the TAS feature extracted by the TAS feature extracting unit 120. The patterns of a lesion may be defined in various ways according to an image type, an analysis purpose, and the like. For example, the lesion may be “malignant” or “benign”.

The lesion classifying unit 130 may classify a pattern of a lesion by applying a TAS feature in a module which is learned from a machine learning algorithm. For example, the machine learning algorithm may include an artificial neural network, a Support Vector Machine (SVM), a decision tree, a random forest, and the like. A learning module may be generated in advance by feature vectors including a TAS feature of every image included in previously-stored image database and learning the feature vectors using a machine learning algorithm. In this example, the lesion classifying unit 130 may classify a pattern of a lesion by rapidly and precisely analyzing lesions included in a following medical image in a sequence using a learning module that is previously learned.

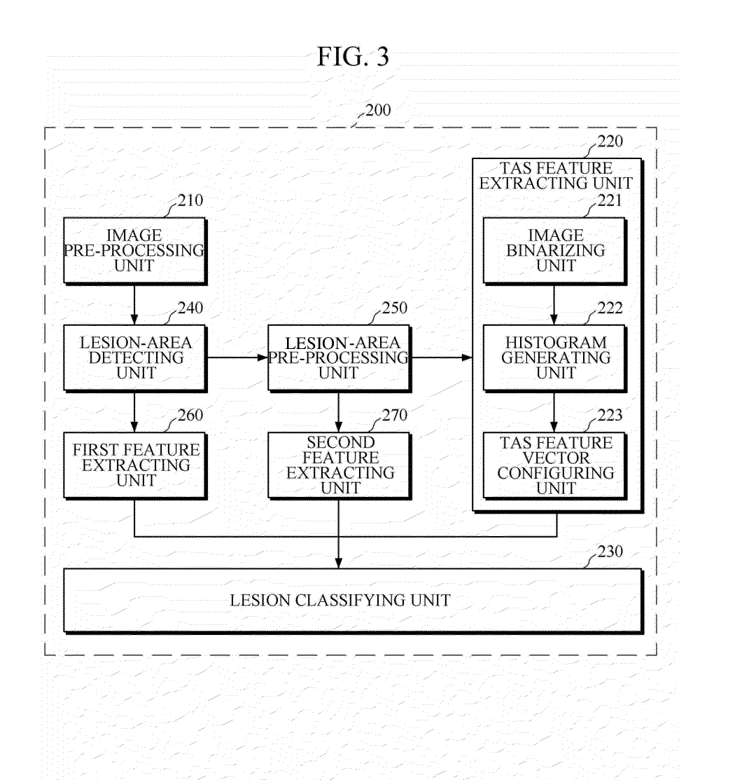

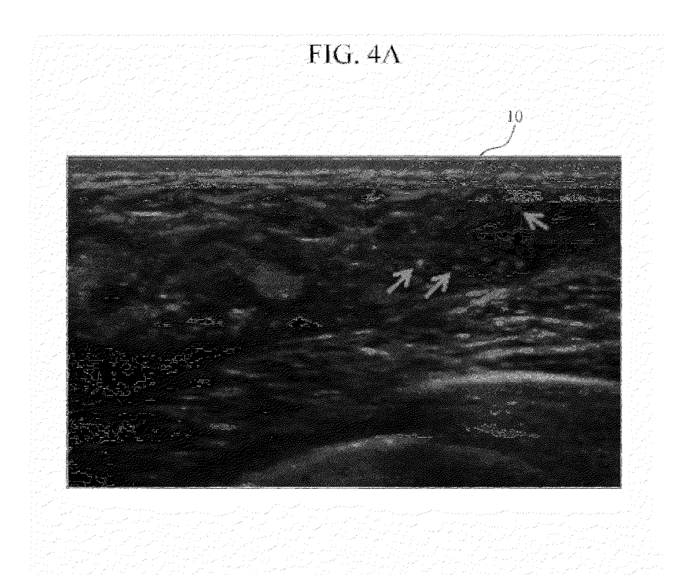

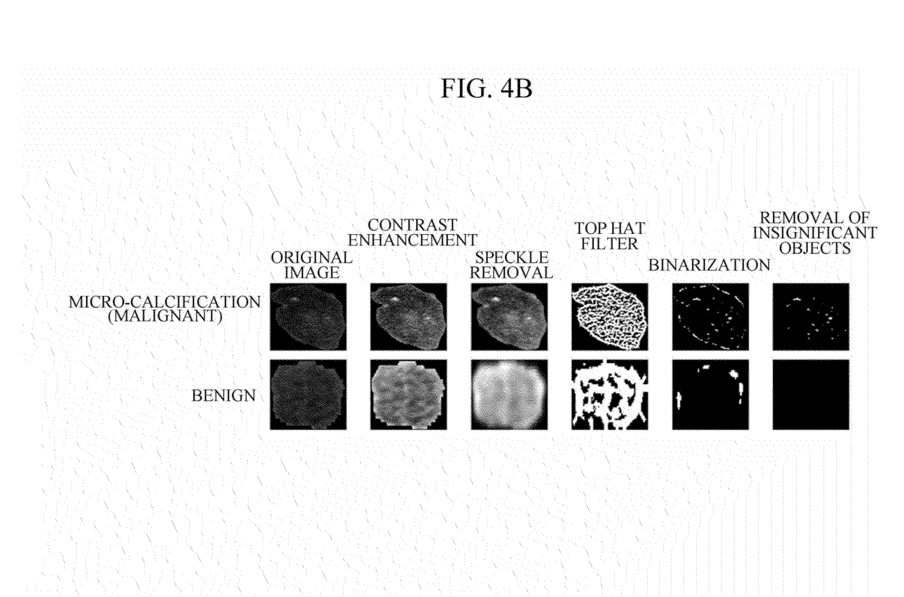

FIG. 3 illustrates another example of an apparatus for analyzing a lesion. FIGS. 4A through 4D illustrate an example of steps of a process for detecting a lesion area and pre-processing the lesion area.

Referring to FIG. 3, an apparatus for analyzing a lesion 200 includes an image pre-processing unit 210, a TAS feature extracting unit 220, a lesion classifying unit 230, a lesion area detecting unit 240, and a lesion area pre-processing unit 250. A hardware device may include the image pre-processing unit 210, the TAS feature extracting unit 220, the lesion classifying unit 230, the lesion area detecting unit 240, and the lesion area pre-processing unit 250 all together, or one or more of the above functional units may be included in another device.

The image pre-processing unit 210, the TAS feature extracting unit 220, and the lesion classifying unit 230 are the same components as described with reference to FIGS. 2A to 2C, accordingly additional descriptions are not provided.

The lesion area detecting unit 240 may detect a lesion with approximate location and size from an image that is captured by a medical measuring device or from a medical image pre-processed by the image pre-processing unit 210. For example, the lesion detecting unit 240 may automatically detect a lesion with a location and a size using a commonly-used algorithm for detecting a lesion area. The lesion area detecting unit 240 may detect a lesion from an entire area of a medical image or from a predetermined area of a medical image by shifting from one medical image to another using a sliding window technique. As another example, if accurate location or size of lesions in a medical image is given, the lesion area detecting unit 240 may detect a lesion based on information received about the location or size of the lesions from a user.

According to various aspects, the apparatuses described herein may include a display to display the medical images including the detected lesion area.

FIG. 4A illustrates an example of an ultrasound image of a breast and a lesion area 10 detected therein. In the upper right-side of FIG. 4A, there is a group of small bright spots, each representing micro-calcification. This area is suspected of being a malignant lesion included in the detected lesion area 10.

The lesion area pre-processing unit 250 may generate an image with a pre-processed lesion area by pre-processing the detected lesion area according to an analytic purpose or a type of the image. For example, the lesion area pre-processing unit 250 may generate the image with a pre-processed lesion area using at least one pre-processing algorithm such as a contrast enhancement algorithm, a speckle removal algorithm, a top hat filter, a binarization algorithm, and the like.

For example, as illustrated in FIG. 4B, each original image may be pre-processed using a contrast enhancement algorithm and a speckle removal algorithm in sequence. Next, a top hat filter may be applied at a local area, such as an area including a micro-calcification, for enhanced contrast. Next, the image may be binarized, and an object or area with high contrast in the binarized image may be seen. Next, by removing insignificant objects, such as objects too big or too small compared to micro-calcification, or objects occurring on the edge of the detected lesion, an image with a pre-processed lesion area may be generated, as shown in the images on the far right in FIG. 4B.

Referring again to FIG. 3, the TAS feature extracting unit 220 may include an image binarizing unit 221, a histogram generating unit 222, and a TAS feature vector configuring unit 223. A TAS feature may be extracted from an image with a pre-processed lesion such as the image generated in the lesion area pre-processing unit 250. The image binarizing unit 221 may binarize the image with a pre-processed lesion area. In addition, the image binarizing unit 221 may generate an inverted binarized image by inverting the binarized image. The histogram generating unit 222 may generate a histogram using a binarized image or an inverted image. The TAS feature vector configuring unit 224 may configure a TAS feature vector based on the generated histogram.

In this example, the apparatus for analyzing a lesion may further include a first feature extracting unit 260 and a second feature extracting unit 270. The first feature extracting unit 260 and the second feature extracting unit 270 may extract a first feature and a second feature of the lesion area, including shape, brightness, texture, correlation with other areas surrounding the lesion area. The TAS feature extracting unit 224 may extract a TAS feature of the lesion area. For example, the first feature extracting unit 260 and the second feature extracting unit 270 may be an analogue digital converter, a signal processing program, a computer for removing any noise and error, and the like.

In this example, the first feature extracting unit 260 may extract a feature as a form of a vector from an image with a lesion area detected by the lesion area detecting unit 240. In addition, the second extracting unit 270 may extract a feature as a form of a vector from an image with a lesion area pre-processed for an analytic purpose. The extracted first feature or the extracted second feature may be received by the lesion classifying unit 230.

The lesion classifying unit 230 may classify a pattern of a lesion using a TAS feature. When receiving a first feature or a second feature from the first feature extracting unit 260 or the second feature extracting unit 270, the lesion classifying unit 230 may classify the pattern of the lesion further using the first feature or the second feature.

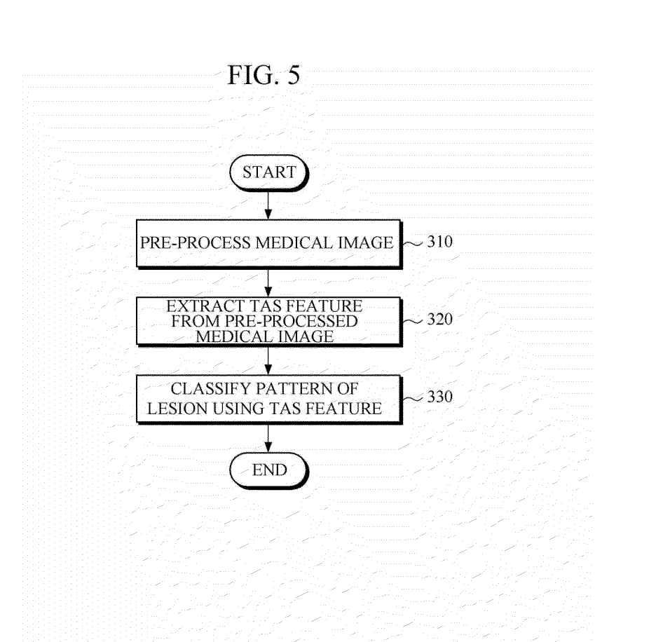

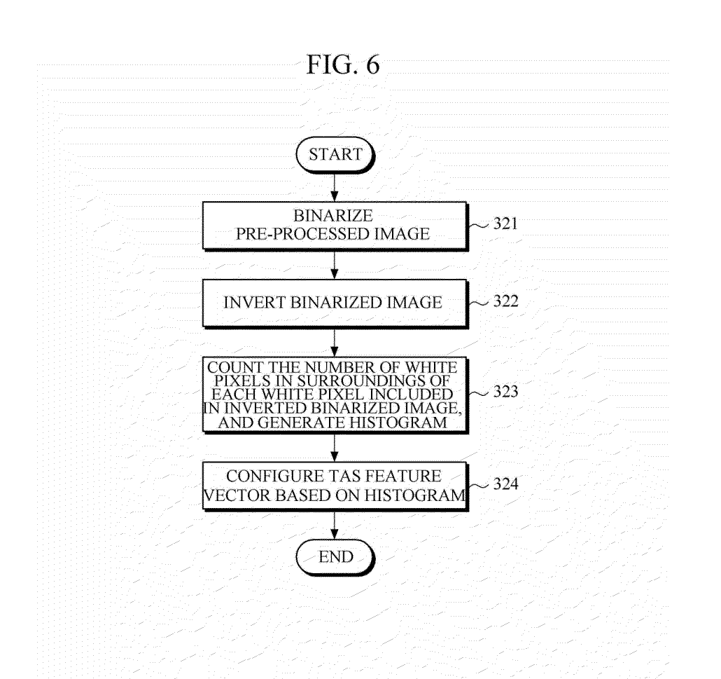

FIG. 5 illustrates an example of a method for analyzing a lesion. FIG. 6 illustrates an example of a method for detecting a TAS feature. The methods of FIGS. 5 and 6 may be performed by the apparatus for analyzing a lesion shown in FIG. 1.

Referring to FIG. 5, a medical image captured by a medical image capture device is pre-processed in 310. For example, the apparatus for analyzing a lesion 100 may receive a breast ultrasound image from an ultrasound device, an MRI image from an MRI device, or a CT image from a CT device, and may pre-process brightness, contrast, and/or color distribution of the received medical image based on an analytic purpose or a type of the medical image.

A TAS feature is extracted from the medical image captured by the medical image capture device or the pre-processed medical image, in 320. Referring to FIG. 6, during the operation for extracting a TAS feature in 320 of FIG. 5, the medical image is binarized in 321 and the binarized image is inverted in 322, as described above with reference to FIGS. 2A and 2C. For example, the apparatus for analyzing a lesion 100 may estimate a value of a pixel intensity of the background in a medical image, calculate an average value μ and a deviation value σ of pixels which have a value of pixel intensity higher than a value of pixel intensity of the background, and binarize the image using the calculated average value μ and the calculated deviation value σ.

Next, the number of white pixels that surround each white pixel in the binarized image or the inverted image is counted, and then a histogram is generated based on the counted number in 323. According to various aspects, different surroundings, or different number of surrounding pixels may be set for an analytic purpose. For example, in the case of a two-dimensional (2D) image, two pixels, four pixels, and the like, such as those on the top, the bottom, the left and the right of a central pixel may be set to be surrounding pixels. As another example, in the case of a three dimensional (3D) image, six pixels, eighteen pixels, twenty-six pixels, and the like, may be set as the surrounding pixels. Lastly, a TAS feature vector is configured based on the generated histogram in 324.

Referring again to FIG. 5, the apparatus for analyzing a lesion 100 may classify a pattern of a lesion using an extracted TAS feature. For example, the pattern of a lesion may be defined according to a type of a corresponding medical image or an analytic purpose. For example, a pattern of a lesion may be defined as “malignant” or “benign.” The apparatus may classify the pattern of a lesion by applying the extracted TAS feature in a learning module which is learned from a machine learning algorithm. The learning module may be generated by configuring feature vectors, including a TAS feature, of every image which is included in previously-stored image database, and learning the feature vectors using a machine learning algorithm.

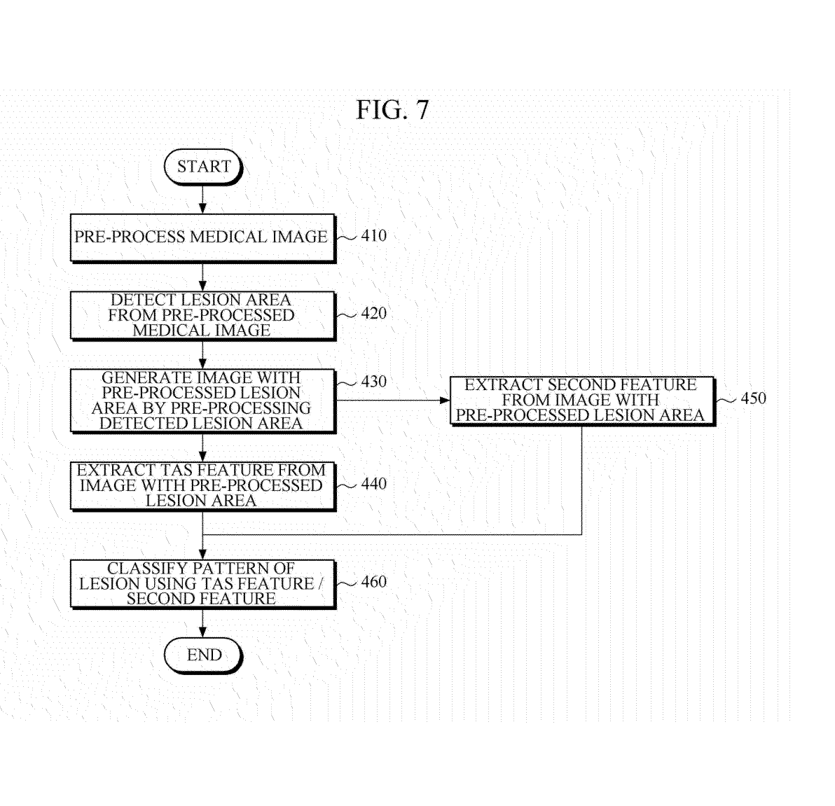

FIG. 7 illustrates an example of a method for analyzing a lesion. For example, the method of FIG. 7 may be performed by the apparatus for analyzing a lesion shown in FIG. 3.

Referring to FIG. 7, in 410, a medical image captured by a medical image capture device is pre-processed. For example, the image may be pre-processed by adjusting brightness, contrast, and/or color distribution of the image.

A lesion area with approximate location and size may be detected from the image captured by the medical image capture device or the medical image pre-processed during an image pre-processing operation, in 420. For example, various algorithms for detecting a lesion area may be used. Meanwhile, information about location or size of the lesion area may be received directly from a user.

In 430, an image with a pre-processed lesion area is generated by pre-processing the detected lesion area. For example, the apparatus for analyzing a lesion 200 may generate an image with a pre-processed lesion area by pre-processing the lesion area using at least one pre-processing algorithm including a contrast enhancement algorithm, a speckle removal algorithm, a top hat filter, a binarization algorithm, and the like.

Next, a TAS feature is extracted from the image with a pre-processed lesion area in 440. For example, a method for extracting a TAS feature from the image with a pre-processed lesion area is described with reference to FIG. 6.

As another example, the apparatus for analyzing a lesion 200 may further extract a second feature of the lesion area from the image with a pre-processed lesion, including shape, brightness, texture and correlation with other areas surrounding the lesion area, in 450. In addition, if the lesion area is detected in 420, the apparatus may further extract a first feature of the lesion area from an image including the detected lesion area, including shape, brightness, texture, and/or correlation with other areas surrounding the lesion area, although not illustrated in FIG. 7.

In 460, a pattern of a lesion is classified using the TAS feature. As another example, if a first feature or a second feature is further received, the pattern of a lesion may be classified using the first feature of the second feature as well as the TAS feature in 460.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion.

For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for analyzing a lesion in an image, the apparatus comprising:
a TAS feature extractor configured to extract a Threshold Adjacency Statistic (TAS) feature from the image; and
a lesion classifier configured to classify a pattern of a lesion in the image based on the extracted TAS feature.

2. The apparatus of claim 1, further comprising:
an image pre-processor configured to pre-process the image by adjusting at least one of brightness, contrast, and color distribution of the image,
wherein the TAS feature extractor is configured to extract the TAS feature from the pre-processed image.

3. The apparatus of claim 1, wherein the TAS extractor comprises:
an image binarizer configured to binarize the image;
an histogram generator configured to generate a histogram based on a number of white pixels that surround each white pixel included in the binarized medical image; and
a TAS feature vector generator configured to generate a TAS feature vector based on the generated histogram.

4. The apparatus of claim 3, wherein the image binarizer is configured to calculate an average value and a deviation value of pixels, each of which have a pixel intensity that is higher than a pixel intensity of a background of the image, and binarize the image using the calculated average value and deviation value.

5. The apparatus of claim 1, wherein the lesion classifier is configured to classify the s pattern of the lesion by applying the TAS feature based on a machine learning algorithm.

6. The apparatus of claim 5, wherein the machine learning algorithm comprises at least one of an artificial neural network, a Support Vector Machine (SVM), a decision tree, and a random forest.

7. The apparatus of claim 1, wherein the lesion classifier is configured to classify the lesion as either malignant or benign.

8. An apparatus for analyzing a lesion in an image, the apparatus comprising:
a lesion area detector configured to detect a lesion area from the image;
a lesion area pre-processor configured to generate an image with a pre-processed lesion area by pre-processing the detected lesion area;
a TAS feature extractor configured to extract a TAS feature from the image with a pre-processed lesion area; and
a lesion classifier configured to classify a pattern of a lesion based on the extracted TAS feature.

9. The apparatus of claim 8, wherein the lesion area pre-processor is configured to generate the image with a pre-processed lesion area using a pre-processing algorithm comprising at least one of a contrast enhancement algorithm, a speckle removal algorithm, a top hat filter, and a binarization algorithm.

10. The apparatus of claim 8, further comprising:
a second feature extractor configured to extract additional features of the lesion area from the image with a pre-processed lesion area, the additional features including at least one of a shape, brightness, texture and correlation with other areas surrounding the lesion area,
wherein the lesion classifier is configured to classify a pattern of a lesion using the extracted second feature.

11. A method for analyzing a lesion in an image, the method comprising:
extracting a TAS feature from the image; and
classifying a pattern of a lesion in the image based on the extracted TAS feature.

12. The method of claim 11, further comprising:
pre-processing the medical image by adjusting at least one of brightness, contrast, and color distribution of the image,
wherein the extracting of the TAS feature comprises extracting the TAS feature from the pre-processed medical image.

13. The method of claim 12, wherein the extracting of the TAS feature comprises:
binarizing the image;
generating a histogram based on a number of white pixels that surround each white pixel included in the binarized image; and
generating a TAS feature vector based on the generated histogram.

14. The method of claim 13, wherein the binarizing of the image comprises calculating an average value and a deviation value of pixels, each having a pixel intensity higher than a pixel intensity of a background of the image, and binarizing the image using the calculated average value and deviation value.

15. The method of claim 11, wherein the classifying of the pattern of a lesion comprises classifying the pattern of a lesion by applying the TAS feature based on a machine learning algorithm.

16. The method of claim 15, wherein the machine learning algorithm comprises at least one of an artificial neural network, a SVM, a decision tree and a random forest.

17. A method for analyzing a lesion in an image, the method comprising:
detecting a lesion area from the image;
generating an image with a pre-processed lesion area by pre-processing the detected lesion area;
extracting a TAS feature from the image with a pre-processed lesion area; and
classifying a pattern of a lesion based on the extracted TAS feature.

18. The method of claim 17, wherein the generating of the image with a pre-processed lesion area comprises generating the image with a pre-processed lesion area using a pre-processing algorithm comprising at least one of a contrast enhancement algorithm, a speckle removal algorithm, a top hat filter, and a binarization algorithm.

19. The method of claim 17, wherein the extracting of the TAS feature comprises:
binarizing the image with a pre-processed lesion area;
generating a histogram based on a number of white pixels that surround each white pixel included in the binarized image; and
generating a TAS feature vector based on the generated histogram.

20. The method of claim 17, further comprising:
extracting additional features of a lesion area from the image with a pre-processed lesion area, the additional features including at least one of a shape, brightness, texture, and correlation with other areas surrounding the lesion area,
wherein the classifying of the pattern of the lesion comprises classifying the pattern of a lesion using the extracted second feature.
